(19) United States
(12) Patent Application Publication
(10) Pub. No.: US 2023/0340981 A1
(43) Pub. Date: Oct. 26, 2023

(54) FURNITURE ELEMENT AND PIECE OF FURNITURE

(71) Applicant: Paul Hettich GmbH & Co. KG, Kirchlengern (DE)

(72) Inventors: Soeren BEUMLER, Buende (DE); Timo SZLAPKA, Bielefeld (DE); Gerrit STAUFENBERG, Muenster (DE); Juergen RUHE, Bad Oeynhausen (DE)

(73) Assignee: Paul Hettich GmbH & Co. KG, Kirchlengern (DE)

(21) Appl. No.: 18/027,437

(22) PCT Filed: Sep. 6, 2021
(86) PCT No.: PCT/EP2021/074494

§ 371 Date: Mar. 21, 2023

(30) Foreign Application Priority Data
Sep. 24, 2020 (DE) 10 2020 124 885.7

(51) Int. Cl. F16B 9/00

(52) U.S. Cl. CPC F16B 9/05; A47B 57/48

(57) ABSTRACT

A quadrangular furniture element, in particular a shelf with at least one bearing plane, has a base, a cover panel, and at least one profiled element which is secured between the base and the cover panel. A translation-rotation fitting is arranged on the base lower face facing away from the cover panel and/or on the cover panel upper face facing away from the base, the translation-rotation fitting being usable for moving the furniture element from a starting position into an open end position and back into the starting position in a combined translation-rotation movement, wherein at least one receiving element for fixing the at least one profiled element is arranged in an edge region of the base and the cover panel. A piece of furniture can have at least one such furniture element.

The present invention relates to a furniture element, in particular a shelf component having at least one bearing plane according to the preamble of claim 1.

The invention further relates to a piece of furniture according to the preamble of claim 20.

Shelves for furniture elements are usually assembled or welded together as frame racks from a large number of hollow sections. Base panels, cover panels as well as side panels are usually inserted into this frame rack and fixed to them.

Furniture elements are usually placed as pieces of furniture, for example in the form of a shelf in a corner of a room or as a component of a piece of furniture in an area, in particular a corner region, of a furniture body and can be moved from a starting position to an open or use position by a combined rotational-translational movement.

For translational-rotational movement, translation-rotation fittings are used, which are mounted on the floor or a ceiling of the furniture element and which have two bearing surfaces that are movable relative to each other with rolling elements guided in running grooves or with sliding elements guided in sliding guides.

It is the object of the present invention to provide a rotatable furniture element with great stability and simplified assembly.

This object is solved by a rotatable furniture element having the features of claim 1.

The object is further solved by a piece of furniture having the features of claim 20.

The rotatable furniture element according to the invention has a base panel, a cover panel and at least one profiled element fixed to the base panel between the base panel and the cover panel.

A translation-rotation fitting is arranged on an underside of the base panel facing away from the cover panel and/or on an upper side of the cover panel facing away from the base panel, with which the rotatable furniture element can be moved in a combined translational-rotational movement from a starting position into an opening end position and back into the starting position.

It is also conceivable that the base panel and/or the cover panel is formed as a component of the translation-rotation fitting.

In an edge region of the base panel and the cover panel, receiving elements are arranged for fixing the profiled elements.

Fixing of the profiled elements directly to the base panel and the cover panel enables simple and precisely executable assembly of such a profiled element.

Due to the possibility of arranging either further profiled elements or the ends of side panels at the other corner points of the base and cover panels, a very individual structure of the rotatable furniture element can be realized.

Advantageous embodiment variants of the invention are the subject matter of the subclaims.

According to an advantageous embodiment variant, the receiving elements extend in the direction of the longitudinal axis of the at least one profiled element.

Particularly preferably, the receiving elements are designed to conically taper away from the edge regions.

This makes it possible to mount the at least one profiled element on the base panel or cover panel in a simple and precisely fitting manner.

The profiled element is preferably designed as a hollow profiled element.

In one embodiment variant, the receiving elements are designed as receiving contours molded onto the base panel or cover panel.

In an alternative embodiment variant, the receiving elements are designed as separate components that are attached to the base panel or cover panel.

According to a preferred further development, each of the receiving elements has a base that can be fixed to the edge region and an insertion socket extending from the base.

According to a further preferred embodiment variant, cover profiles can be attached to the edge regions, enabling the mounting regions to be covered in a simple manner.

According to a further preferred embodiment variant, the running grooves or sliding guides are shaped in such a way that the base surface of the furniture element in the starting position is congruent with the base surface of the furniture element in the opening end position.

According to a further embodiment variant, the rotational portion of the movement between the starting position and the opening end position is preferably 90° or 180°.

The piece of furniture according to the invention has a fixed furniture body and a furniture element rotatably mounted in the furniture body, in particular a shelf having at least one bearing plane, which is designed as described above.

In a preferred embodiment variant, a side panel designed as a retaining plate is mounted in at least one of the side openings of the furniture element, to which a decorative panel can be attached.

According to a further advantageous design of the piece of furniture according to the invention, the side panel of the furniture element is attached to the base panel and the cover panel via fastening elements.

In this case, the fastening elements, such as dowels, can be arranged directly in the base and cover panel or in additional cover profiles arranged on the outside of or on the base and cover panel.

Also, the base panel and cover panel may still each have an interior decorative panel so that the fastening elements are not visible.

Furniture elements are possible which have four profiled elements in the corner regions of the base panel and the cover panel. The side panels are dimensioned so that they can be arranged between the profiled elements.

This variant offers the advantage that fastening elements for the at least one shelf can be integrated into the profiled elements.

In an alternative design of a piece of furniture according to the invention, a profiled element is arranged in only one corner of the base panel and the cover panel of the furniture element. The other corners are formed by perpendicularly abutting end edges of side panels or decorative panels, each of which is fastened to the base panel and in the cover panel. For design reasons, the abutting edge can be covered by a cover.

In the case of large pieces of furniture, it may be necessary or desirable for the furniture element to require additional profiled elements in the area of the side openings between the corner regions of the base panel and cover panel. In this case, receiving elements are preferably also provided in the corresponding regions.

According to another preferred embodiment variant, the side panel has adjustment elements for fixing and aligning the decorative panel.

According to a first embodiment variant, the at least one profiled element is tubular with a rectangular base surface.

According to an alternative embodiment variant, the at least one profiled element is tubular with a ring-segment-shaped base surface.

According to a further alternative embodiment variant, the at least one profiled element is formed as a tubular connecting member of two side walls integrated therewith with a ring-segment-shaped base surface, which on the one hand enables a simple structure and on the other hand enables further design options of side walls of the furniture element.

Preferred exemplary embodiments are explained in more detail below with reference to the accompanying drawings, wherein:

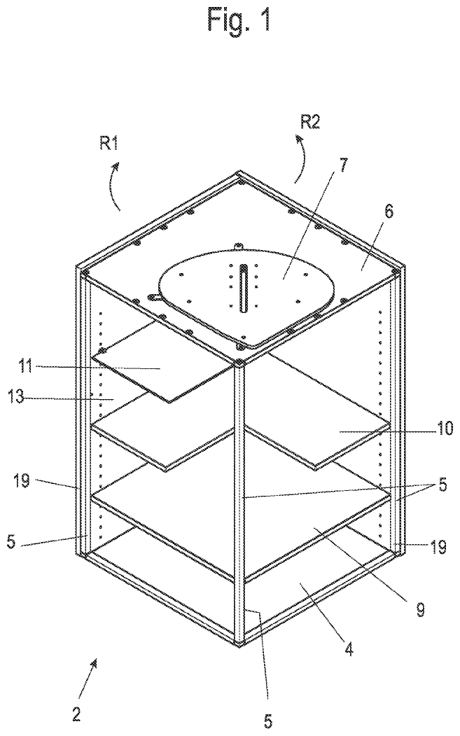

FIG. 1 shows a perspective view of an embodiment variant of a furniture element according to the invention without representation of the furniture body at least partially enclosing it,

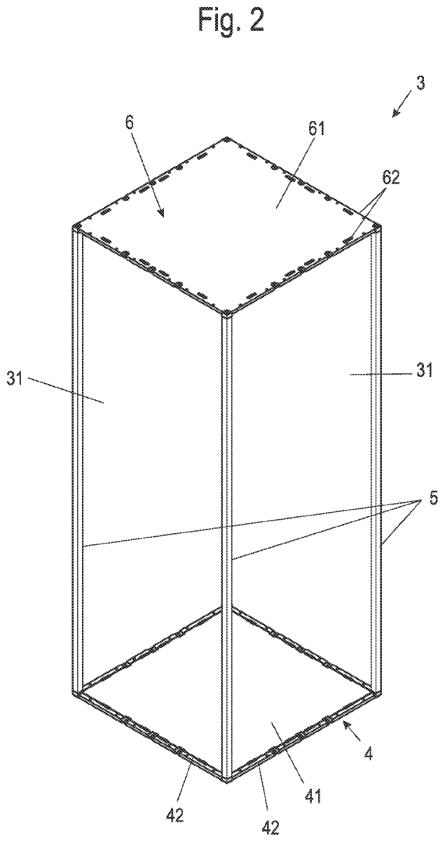

FIG. 2 shows a perspective view of an embodiment variant of a furniture element according to the invention without representation of the furniture body which at least partially surrounds it and without side walls with the translation-rotation fitting hidden,

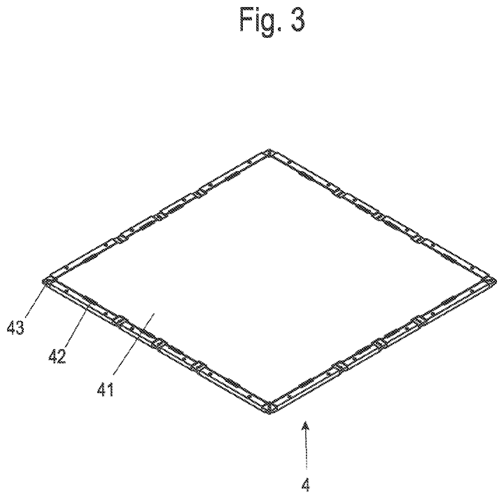

FIG. 3 shows a perspective view of an embodiment variant of a base panel,

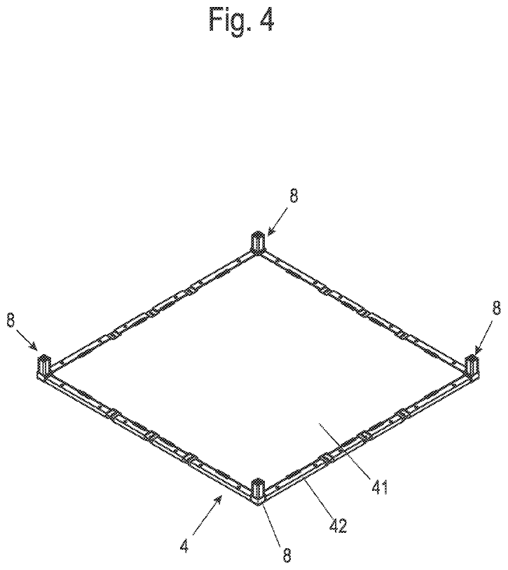

FIG. 4 shows a perspective view of the base panel of FIG. 3 with receiving elements attached to it,

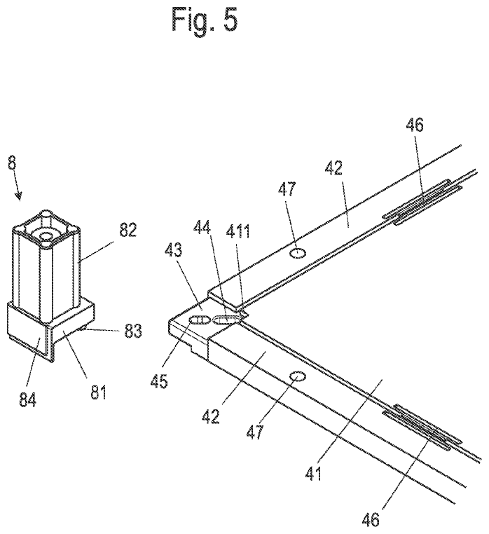

FIG. 5 shows a detailed perspective view of a receiving element and a section of the base panel,

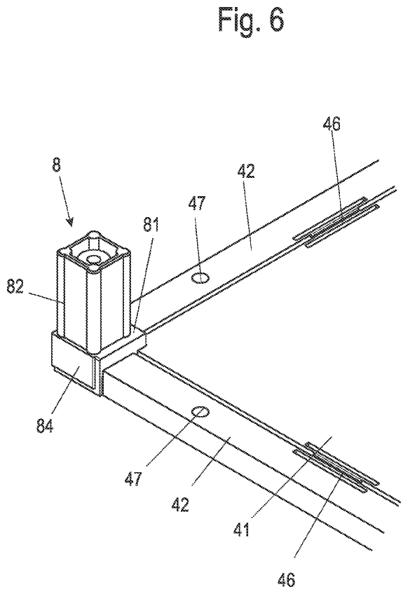

FIG. 6 shows a perspective view corresponding to FIG. 5 in the assembled state of the receiving element on the base panel,

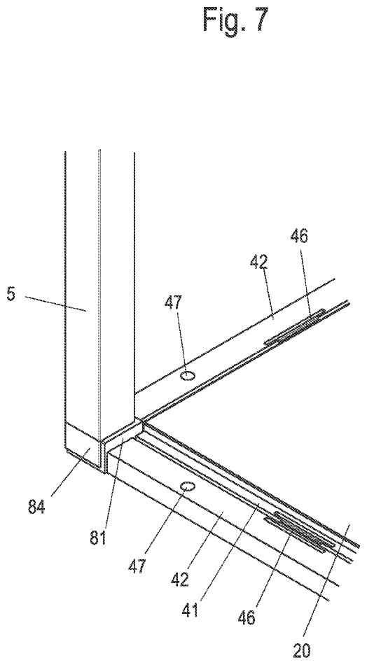

FIG. 7 shows a perspective view corresponding to FIG. 6 with the profiled element placed on the receiving element,

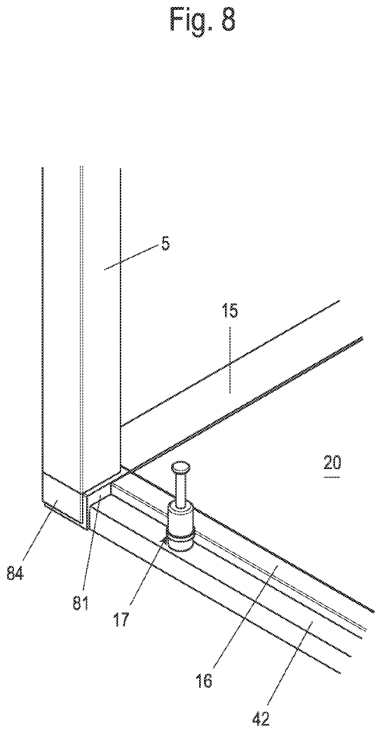

FIG. 8 shows a perspective view corresponding to FIG. 7 with dowels and cover profiles additionally arranged at the edge region as well as a base support,

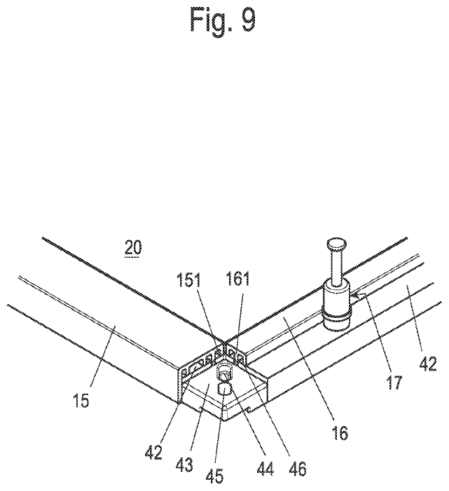

FIG. 9 shows a perspective view of the base panel with the base support and cover profiles placed on it before the receiving element is attached,

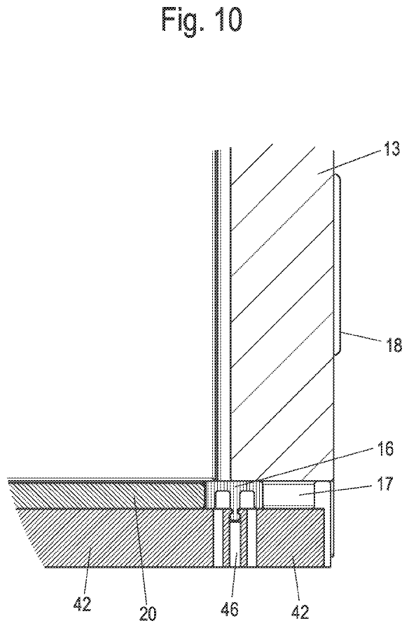

FIG. 10 shows a sectional view through a region of the furniture element with clipped-in cover profile and side panel placed on the edge region,

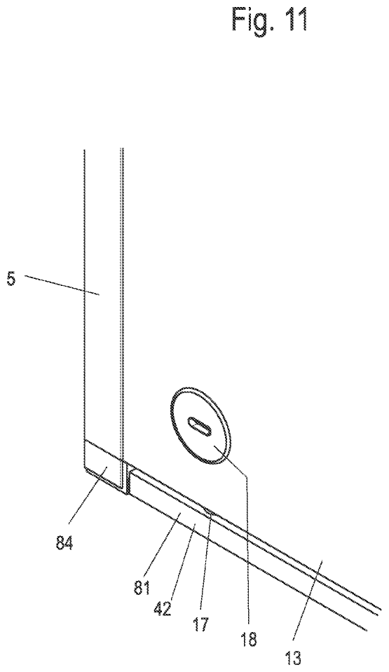

FIG. 11 shows a perspective view of a section of the furniture element with side panel attached thereto and adjustment element inserted therein,

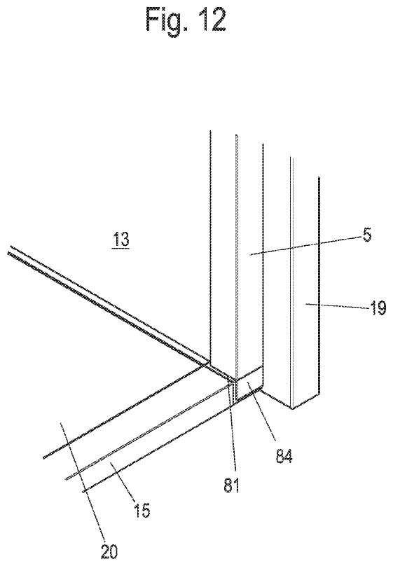

FIG. 12 shows a perspective view of the arrangement shown in FIG. 11 from another perspective with the decorative panel mounted,

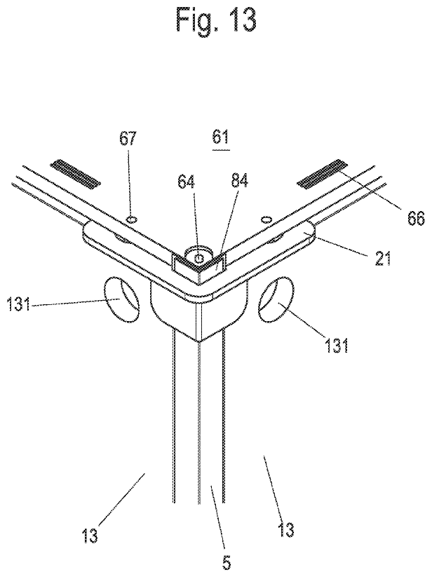

FIG. 13 shows a perspective view of a section of the not yet completely assembled furniture element with cover panel and attached assembly tool,

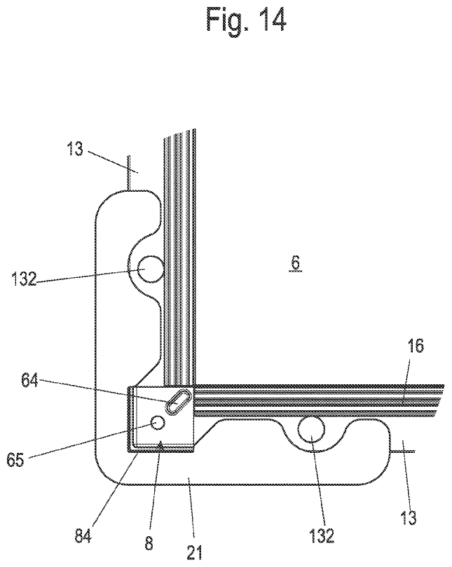

FIG. 14 shows a top view of the arrangement shown in FIG. 13,

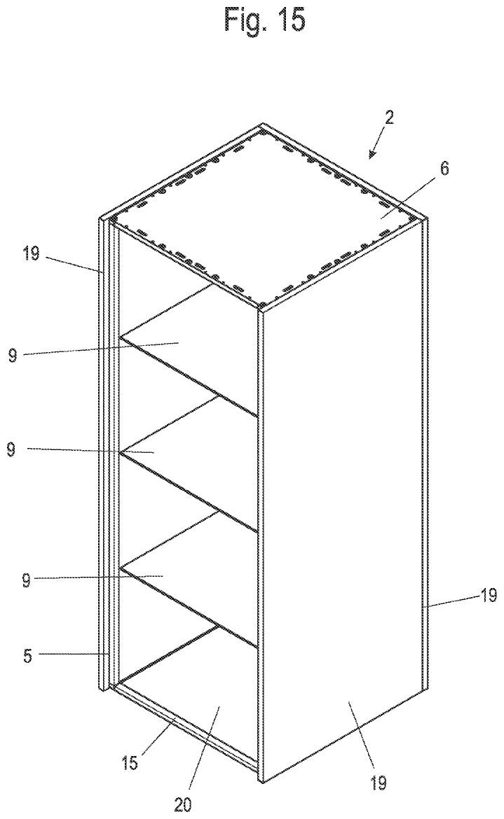

FIG. 15 shows a perspective view of a furniture element with a profile construction and shelves built into it as well as a plurality of side panels and decorative panels attached thereto,

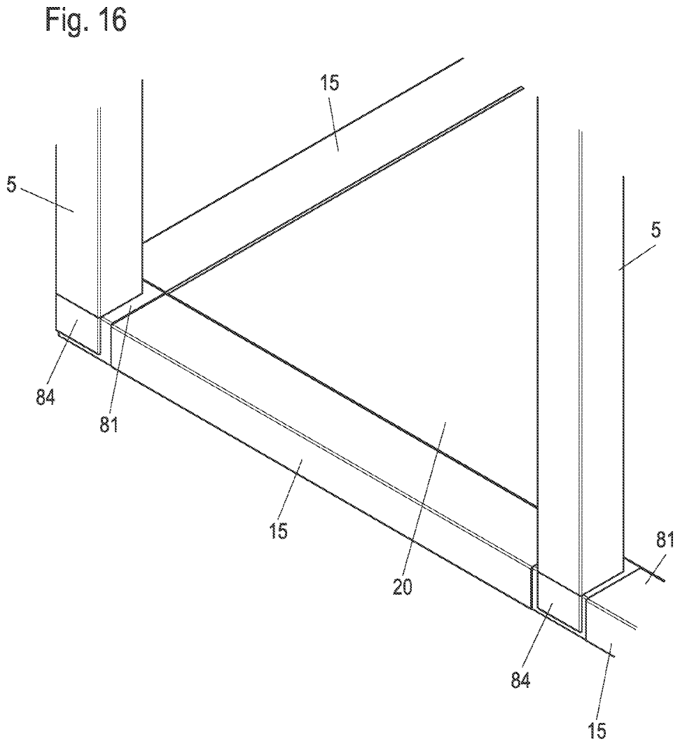

FIG. 16 shows a perspective view corresponding to FIG. 6 with a profiled element additionally attached between two corner regions,

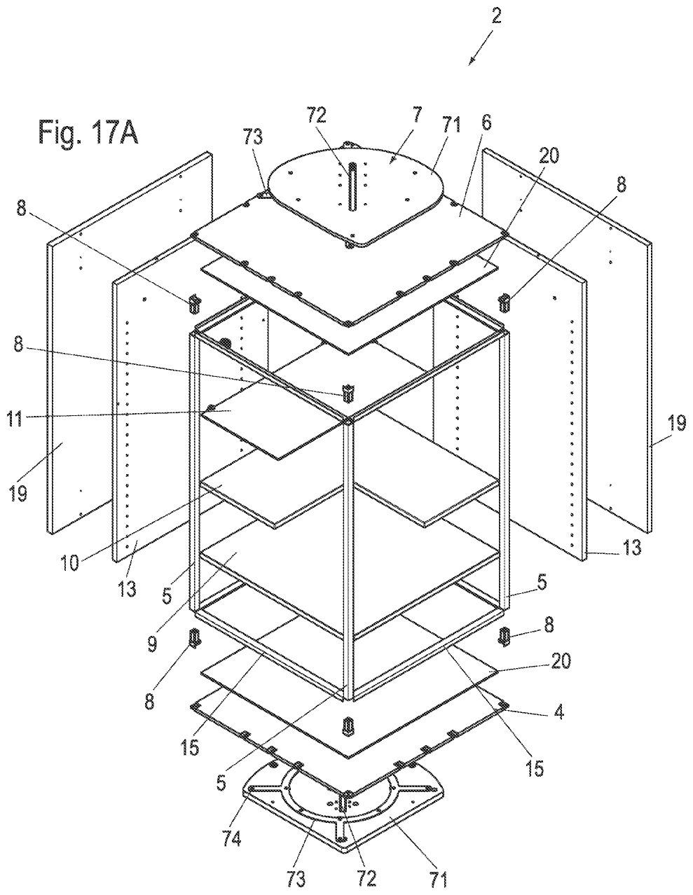

FIGS. 17A and 17B show two perspective exploded views of a furniture element, shelves installed therein as well as a plurality of side panels and decorative panels attached thereto as well as translation-rotation bearings arranged on the base and cover,

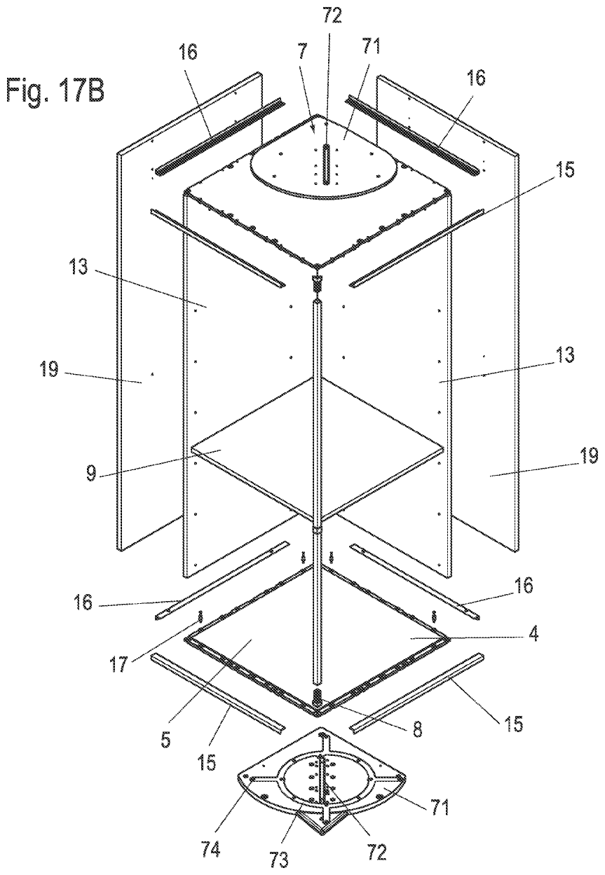

FIG. 18 shows a perspective view of a furniture element with a profiled element arranged at only one corner,

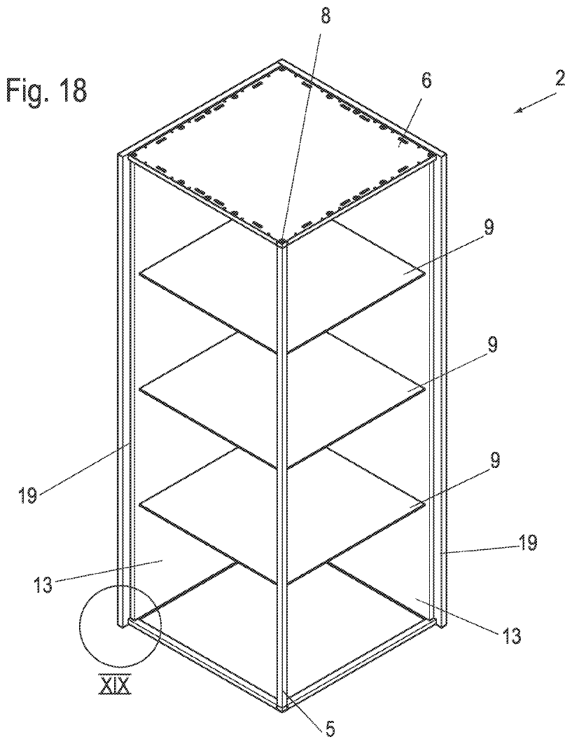

FIG. 19 shows a perspective view of a detail labeled XIX in FIG. 18,

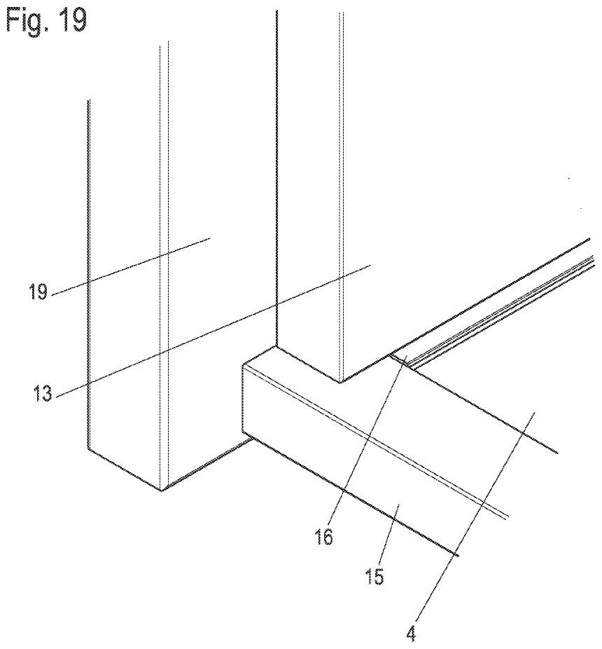

FIG. 20A shows a perspective view of a corner formed by two side walls of the furniture element shown in FIG. 18,

FIG. 20B shows a perspective view of an embodiment variant of a base panel with a receiving element,

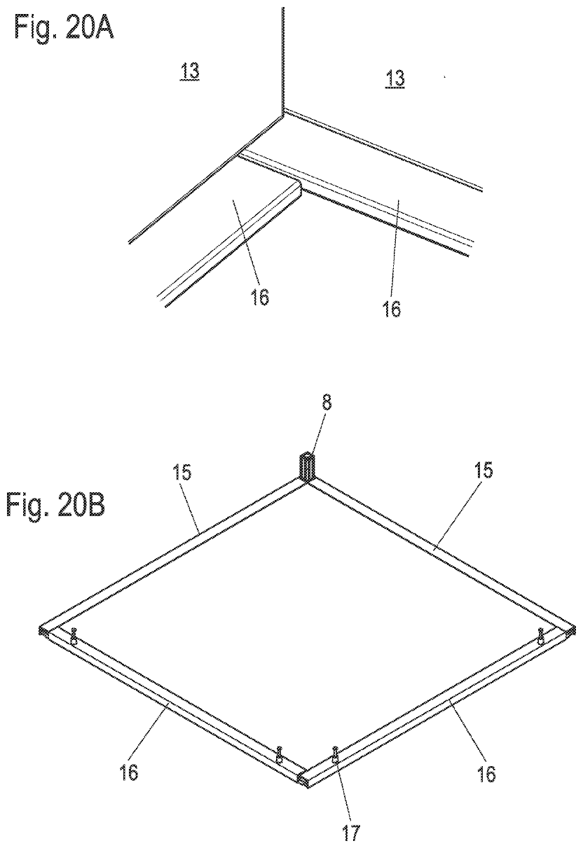

FIG. 21 shows a sectional view through the furniture element shown in FIG. 18 with dowels arranged at the edge region for fixing the side panel,

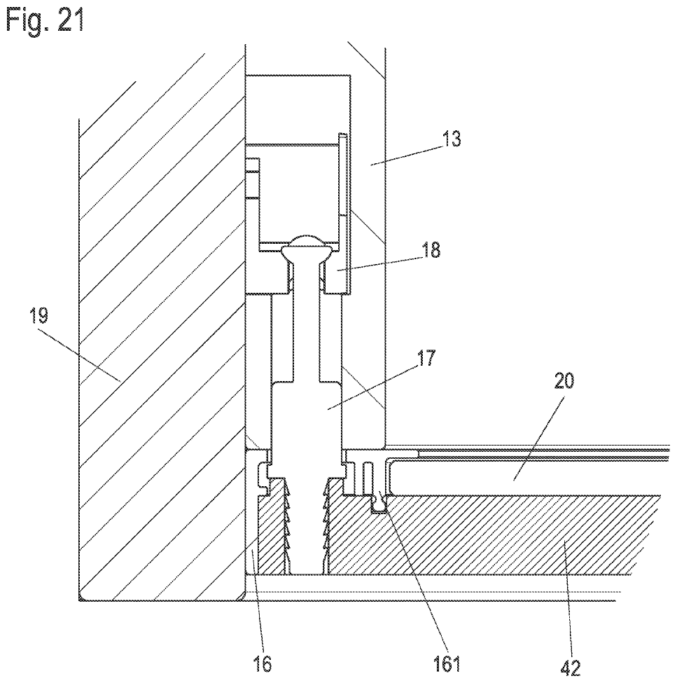

FIG. 22A shows a perspective view of a further embodiment variant of a furniture element with a profiled element accommodating two side walls,

FIG. 22B shows a top view of the furniture element shown in FIG. 22A,

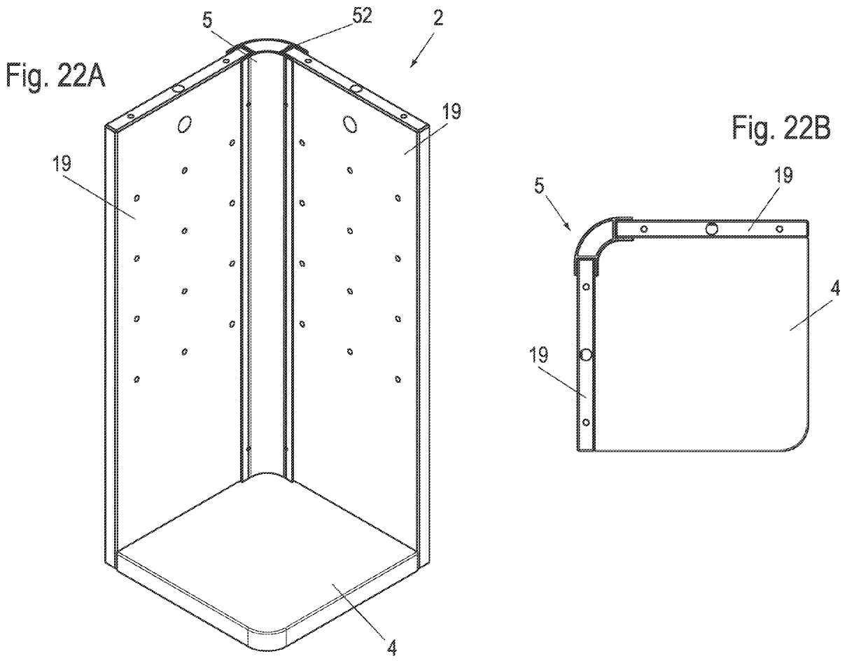

FIGS. 23A, B show views corresponding to FIGS. 22A, B of a further embodiment variant of a furniture element having a side wall covering two side regions with a profiled element integrated therein and a further profiled element on the diagonally opposite side of the furniture element,

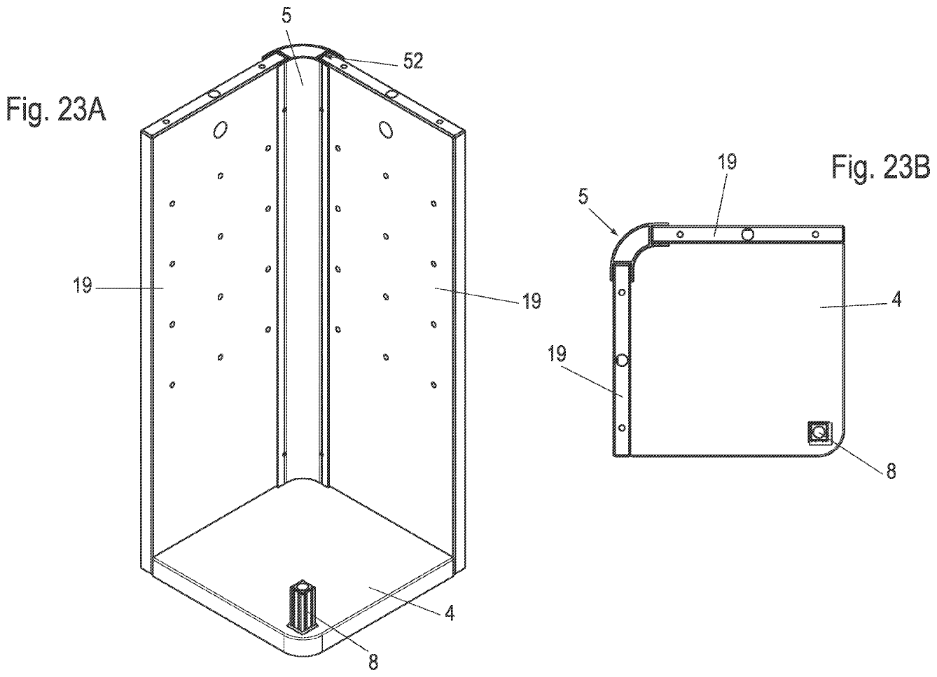

FIGS. 24A, B show views corresponding to FIGS. 22A, B of a further embodiment variant of a furniture element with a side wall covering two side regions with a profiled element integrated therein,

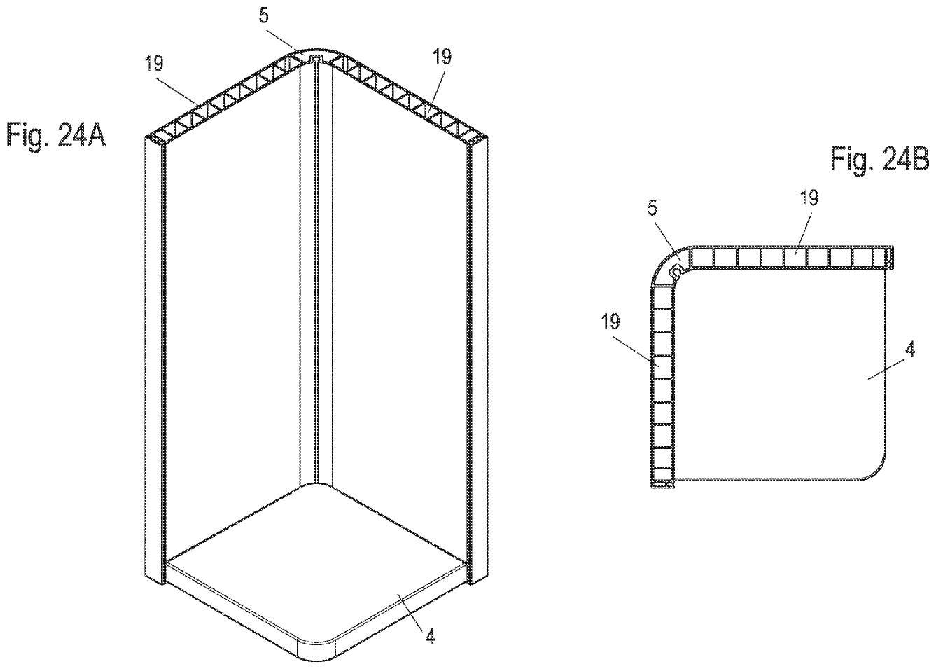

FIGS. 25A, B show views corresponding to FIGS. 24A, B of a further embodiment variant of a furniture element with a side wall covering two side regions with a profiled element integrated therein and a further profiled element on the diagonally opposite side of the furniture element,

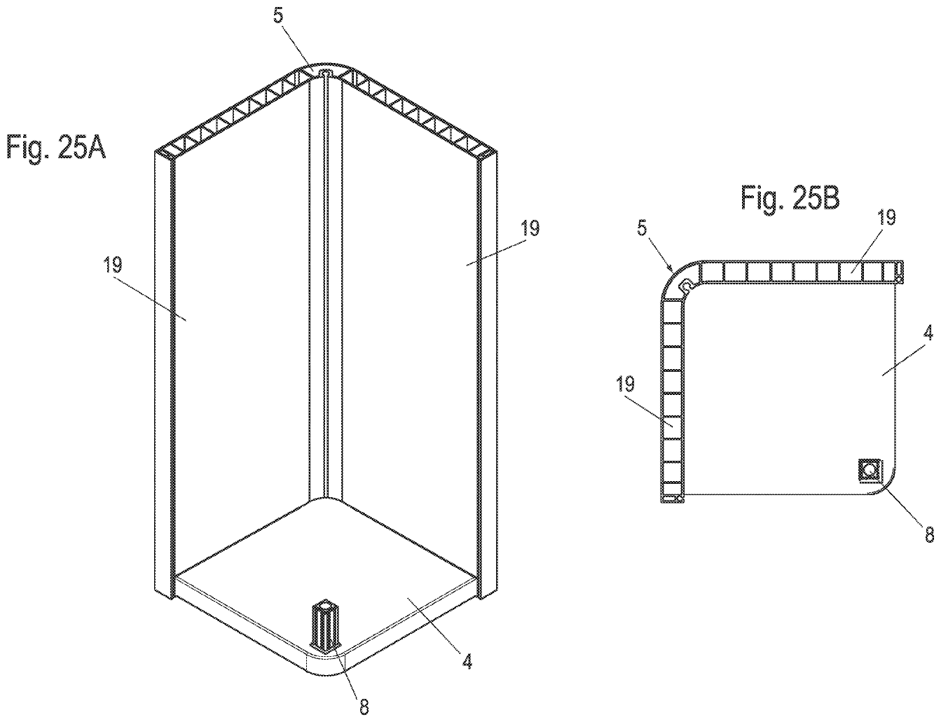

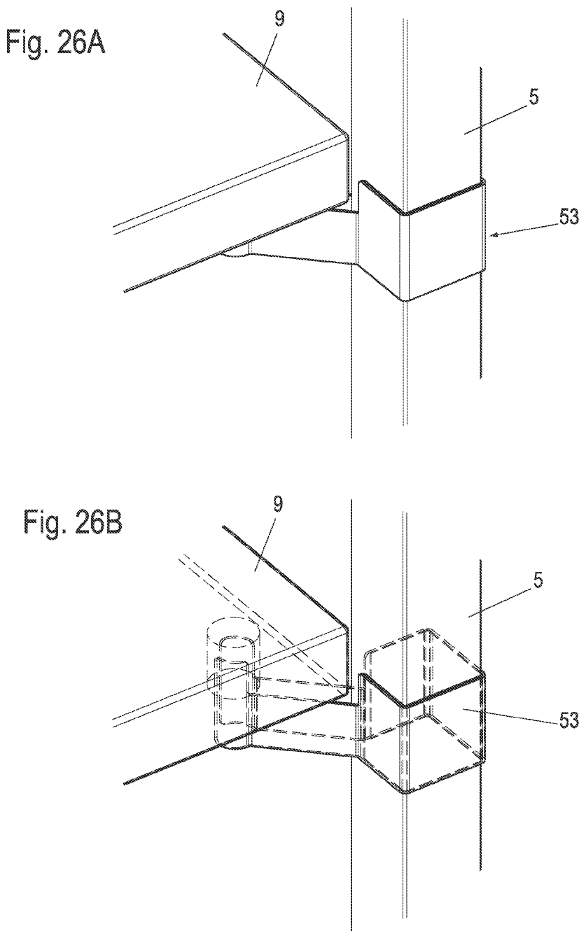

FIGS. 26a, 26B and 27 show perspective illustrations of fastening options for shelves on profiled elements, and

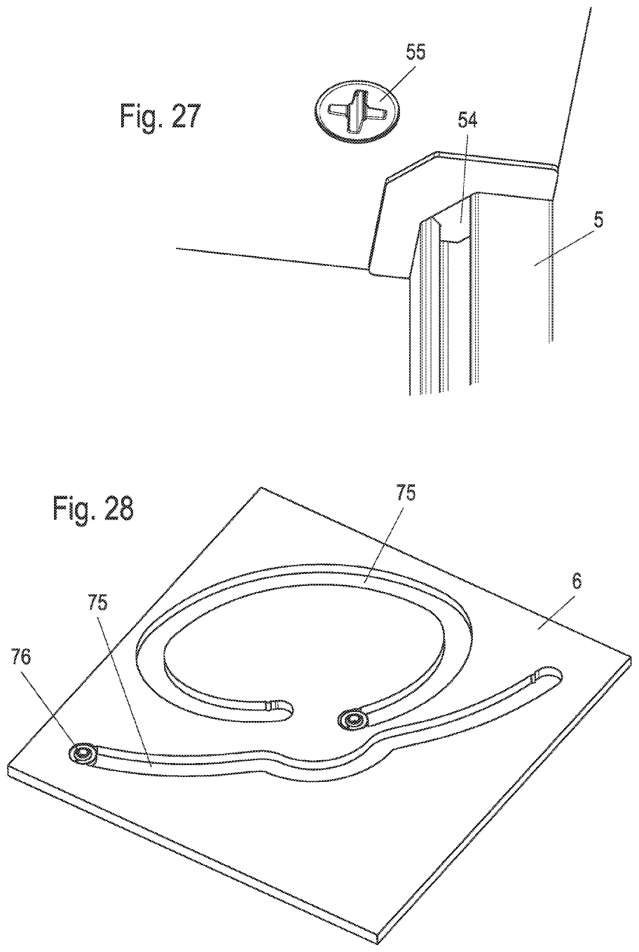

FIG. 28 a perspective view of a cover panel of the translation-rotation fitting as a sliding guide.

In the following description of figures, terms such as top, bottom, left, right, front, rear, etc. refer exclusively to the exemplary representation and position of the profile construction, furniture element, base panel, cover panel, profiled element, edge region and the like selected in the respective figures. These terms are not to be understood restrictively, i.e. due to different working positions or the mirror-symmetrical design or the like, these references may change.

In FIG. 1, the reference sign 2 indicates an embodiment variant of a furniture element according to the invention. The furniture element 2 has a profile construction 3 described in more detail below with reference to FIGS. 2-17.

In the profile construction 3, three shelves 9, 10, 11 are arranged in the embodiment variant shown here, which, however, are to be regarded merely as exemplary variants, both in their design as a shelf occupying the entire base area, as represented by shelf 9, or an L-shaped design according to shelf 10, or also a rectangular design occupying only a partial area of the base area of the profile construction 3, as represented by shelf 11.

As can also be seen from FIG. 2, the profile construction 3 has a base panel 4, a cover panel 6 and a plurality of profiled elements 5 fixed to the base panel 4 and the cover panel 6.

In the exemplary embodiment shown, four vertically oriented profiled elements 5 are provided, which are arranged in respective edge regions 42, 62 of the base panel 4 and the cover panel 6, here in the respective corners.

The profiled elements 5 of the profile construction 3, together with the base panel 4 and the cover panel 6 in the assembled state, as shown in FIGS. 1 and 2, form a cuboid with a rectangular, in particular square, base area with at least two side openings 31; in the exemplary embodiment shown in FIG. 2, four side openings 31 can be seen. A fourth profiled element 5 is concealed by the front profiled element 5.

In most designs, as seen in FIG. 1, two side openings 31 are filled by side panels 13. Only one or more than two side panels 13 can also be used, depending on the geometry of the furniture element 2 and the size of the side panels 13. For design reasons, different, in particular differently colored or side panels 13 made of other materials can also be used in a side opening 31, which can be separated by additional profiled elements 5, for example.

As further shown in FIG. 1, a translation-rotation fitting 7 is shown on an upper side of the cover panel 6 facing away from the base panel 4. With this, the furniture element 2 can be moved in a combined translational-rotational movement from a starting position to an opening end position and back to the starting position.

Further, in FIG. 1, another translation-rotation fitting 7 is mounted on an underside of the base panel 4 facing away from the cover panel 6.

Further, in the furniture element 2 shown in FIG. 1, two side panels 13 are shown which are mounted in or on the profile construction 3. Decorative panels 19 are attached to the outer sides of these side panels 13.

The furniture element 2 can be rotated in rotational directions R₁, R₂ by manual operation.

For fastening the profiled elements 5 to the base panel 4 and the cover panel 6, receiving elements 8 are arranged in edge regions 42, 62 of the base panel 4 and the cover panel 6 for fixing the profiled elements 5, as shown by way of example in FIGS. 4 to 7.

The receiving elements 8 are arranged on the surface of the edge regions 42 of the base panel 4 facing the cover panel 6 and extend in the direction of the longitudinal axis of the profiled elements 5 in the direction of the cover panel 6. These receiving elements 8 can be formed on the base panel 4 or the cover panel 6 as receiving contours according to an embodiment variant not shown here.

FIGS. 4 to 6 show an example of the arrangement of the receiving elements 8 on the base panel 4. The arrangement of the receiving elements 8 on the cover panel 6 is designed accordingly.

In the embodiment variant shown here, the receiving elements 8 are designed as separate components that can be attached to the edge region 42 of the base panel 4 or the edge region 62 of the cover panel 6.

Each of the receiving elements 8 preferably has a base 81 from which an insertion socket 82 extends in the direction of the longitudinal axis of the profiled elements 5.

In this case, the insertion socket 82 is preferably conically tapered in a direction away from the edge regions 42, 62 of the base panel 4 and the cover panel 6.

As shown in FIG. 5, mounting regions 43 of the edge regions 42, 62 of the base panel 4 and the cover panel 6 have recesses 44, 45, 64, 65 which, in the case of the recesses 44, 64, serve to accommodate a projection 83 corresponding to the shape of the recess 44, 64 on the underside of the base 81 facing away from the insertion socket 82.

The recess 45 is designed here as an elongated hole and serves to accommodate preferably a screw that can be screwed into the receiving element 8 from the underside of the base panel 4.

The design of the recess 45 as an elongated hole makes it possible to adjust the receiving element 8 on the base panel 4 in a simple manner. The elongated hole is aligned diagonally to the sides and allows the screw to be moved in the elongated hole, which may be necessary, for example, in the case of profiles of different sizes (e.g. in increments of 16×16 mm to 20×20 mm profile thickness) if the screw is screwed centrally into the receiving element and the outer surface of the profiled element 5 is not to move as a result.

While in the embodiment variant shown in FIGS. 5 to 7 the profiled element 5 is arranged in a corner region of the furniture element 2, it is also conceivable, particularly in the case of large pieces of furniture, that additional profiled elements 5 are required in the area of the side openings between the corner regions of the base panel 4 and cover panel 6 to stabilize the furniture element 2. In this case, receiving elements 8 for mounting additional profiled elements 5 are also provided in the corresponding areas, as shown by way of example in FIG. 16.

It is also conceivable that the additional profiled elements 5 can be used to insert partition walls or other dividing elements or wall configurations. This allows the furniture element to be designed very individually.

To conceal the mounting regions of the base panel 4 and the cover panel 6, in a preferred embodiment variant cover profiles 15, 16 are provided which can be attached to the edge regions 42 of the base panel 4 or edge regions 62 of the cover panel 6.

For fastening the cover profiles 15, 16, cutouts 46, 66 are preferably provided on the base panel 4 or the cover panel 6, in this case in the form of slot-shaped cutouts 46, into which corresponding clip elements 151, 161 of the cover profiles 15, 16 can be clipped. The clip elements 151, 161 can be arranged at different positions of the cover profiles 15, 16, and as an alternative to the assembly from above shown here, assembly can also be carried out, for example, from the side or from another direction.

This allows easy attachment of the cover profiles 15, 16 in the edge regions 42, 62.

The cover profiles 15 thereby embrace the edge region 42 of the base panel 4 both at its vertical end edge and at the upper side of the edge region 42 facing the cover panel 6 and are used in particular at edge regions 42, 62 where no side panel is inserted into a corresponding side opening 31 of the profile construction 3.

On an edge region 42, 62, which serves to receive a side panel 31, corresponding cover profiles 16 are preferably provided, which serve as an outer boundary for a decorative panel 20 to be placed on the floor 41 of the base panel 4.

It is also conceivable to insert the cover profiles 15 here or to place the side panel 31 directly on the edge region 42, 62 of the base panel 4 or cover panel 6.

This aperture profile 16 does not extend to the vertical outer edge of the edge region 42 of the floor element, but only engages over a partial area of this edge region 42.

Near the vertical outer edge of the edge regions 42, 62 of the base panel 4 and the cover panel 6, respectively, holes 47 are provided which serve to accommodate and fix a fastening element 17, in particular a dowel, which is accommodated in corresponding holes 132 of a side panel 13, as can be seen in FIG. 10 and FIG. 14.

The floor 41 or the top 61 are preferably provided with a rectangular cutout 411 in the corner region in which the receiving element 8 is mounted, into which a corner of the base 81 of the receiving element 8 can project, depending on the adjustment of the receiving element 8 on the base panel 4.

The cover profiles 15, 16 completely enclose this corner of the base 81 of the receiving element 8, so that a decorative panel 20 placed on the floor 41 can be formed without such a recess.

In order to make the vertical surfaces of the edge regions 42, 62 flush right into the corners, cover strips 84 are preferably also integrally formed on the receiving elements 8, as shown for example in FIGS. 5 to 8.

As shown in FIGS. 10 to 13, in the case of the furniture element 2, in which a side panel 13 is inserted in the profile construction 3 on at least one side and is preferably fixed in the profile construction 3 by means of the fastening elements 17, adjustment element receptacles 131 are provided, shown for example in FIG. 13, in which adjustment elements 18 are accommodated, which serve to fix and align decorative panels 19 arranged outside the profile construction 3, as shown by way of example in FIG. 15.

For easy assembly of these side panels 13, an assembly tool 21 can be used, as shown in FIGS. 13 and 14, which holds the side panel 13 positively on the outside and frictionally on the inside during assembly.

FIG. 17A shows a perspective exploded view of an embodiment variant of a furniture element 2 corresponding to the furniture element 2 shown in FIG. 1. As can be further seen here, a decorative panel 20 is inserted in each case on the base panel 4 and under the cover panel 6 in order to conceal any regions of the base panel 4 or the cover panel 6 not concealed by the cover profile 15 and/or possibly components of the translation-rotation fitting 7.

FIG. 17B shows a perspective exploded view of an embodiment variant of a furniture element 2 corresponding to the furniture element 2 shown in FIG. 18. The differences to the embodiment in FIG. 17A are described in detail below.

FIG. 17A also shows the basic structure of the translation-rotation fitting 7 used here. The translation-rotation fitting 7 essentially consists of a bearing panel 71 with a slot 72 for guiding the translational portion of the movement of the cuboid furniture element 2. A rolling element cage 73 with a plurality of rolling elements 74, which can be guided in running grooves on the upper side of the cover panel 6 or the bottom side of the base panel 4, is arranged between the bearing panel 71 and a bottom side of the base panel 4 or an upper side of the cover panel 6. It is also conceivable to have a separate panel attached to the upper side of the cover panel 6 or the underside of the base panel 4, in which the running grooves are provided.

As an alternative to the bearing arrangement by means of rolling elements 74 in raceways, a sliding bearing arrangement can also be provided, in which sliding elements are guided in suitably shaped sliding guides.

In the further embodiment variant of a furniture element 2 shown in FIG. 18, only one profiled element 5 is provided at a corner region of the furniture element 2. The other three corners of this furniture element 2 are formed here by the edges of the side panels 13. As shown in the detailed illustration in FIG. 19, the side panels 13 project beyond an edge region of the base panel 4, here concealed by one of the cover profiles 16, to beyond the further cover profile 15 extending perpendicularly thereto and thus stabilize the structure of the furniture element 2. The two side panels 13, which define two side surfaces of the furniture element 2, are each covered on the outside by a decorative panel 19.

It is also conceivable to form the base receptacle out of the base panel 4.

In the rear corner, which cannot be seen in FIG. 18, an end face of one side panel 13 abuts the inner face of the second side panel 13 arranged perpendicularly thereto. Here, too, one of the side panels 13 covers a second cover profile 16 with its end region. The corner region of the furniture element is accordingly formed here by edges of adjacent side panels 13 arranged close to one another or touching one another.

FIG. 20B shows a base panel 4 with a receiving element 8 and four fastening elements 17 for a furniture element according to FIGS. 17B and 18.

FIG. 21 shows a sectional view to illustrate the fastening of the side panel 13 with the aid of the fastening element 17, which on the one hand, here in the example of mounting on the base panel 4, is inserted in the edge region 42 of the base panel 4 and projects upwards into a vertical hole in the side panel 13 as far as the receiving region of the adjustment element 18. The clip element 161 is shown here as clipping in from above, but in another preferred embodiment the cover profile 16 is clipped in from the side.

The detail also shows the fixation of the decorative panel 20 by the cover profile 16. In addition, the decorative panel 20 is fixed here by the receiving element 8 (not shown here).

The subsequent fixation of the decorative panel 20 is important for the assembly/disassembly and for accommodating the cover on the top 61.

FIGS. 22A and 22B show a partial area of a further embodiment variant of a furniture element 2 according to the invention. In this embodiment variant, the profile 5, which is fixed in the base panel 4 and the cover panel 6 by means of a receiving element 8 not shown here, is not rectangular but is designed in cross-section as a rounded corner piece, having two grooves 52 formed on its end faces, between which a respective vertical edge region of the adjacent decorative panels 19 is accommodated.

In the alternative similar embodiment variant according to FIGS. 23A and 23B, in the front edge region 42 of the base panel 4 there is a further receiving element 8 for fixing a rectangular profiled element 5 preferably shown as in the previously described figures.

Depending on the size of the furniture element 2, this additional profiled element 5 can also be dispensed with, or several profiled elements 5 can be provided. There only has to be at least one profiled element 5, which is connected to the base panel 4 and the cover panel 6 via receiving elements 8.

Possibly, instead of the profiled element 5 in the form of a rounded corner piece, only a cover for the end edges of the decorative panels 19 can be used without fixing to the base panel 4 and cover panel 6 if the stability is sufficient.

Further additional alternative embodiment variants of such furniture elements 2 are shown in FIGS. 24A, B and 25A, B. Here, the profile 5 is designed as an integral part of a corner piece comprising two sides of the furniture element 2, fixed via a receiving element 8 in the base panel 4 and the cover panel 6, with two decorative panels 19 connected to vertical side walls of the profile 5.

In the front edge region 42 of the base panel 4, there is a further profiled element 5 in the variant according to FIGS. 25A and 25B. Depending on the size of the furniture element 2, this additional profiled element 5 can also be dispensed with, or several profiled elements 5 can be provided. There need only be at least one profiled element 5, which is connected to the base panel 4 and the cover panel 6 via receiving elements 8.

In the variants described with reference to FIGS. 22 to 25, the decorative panels 19 are not attached to side panel 13, but are fixed directly to base panel 4 and cover panel 6 by fastening means (not shown).

FIGS. 26A and 26B show an example of how a shelf 9, 10, 11 can be fastened to a profiled element 5 by means of a holder 53. The holder 53 can be fixed in corresponding recesses on the profiled element 5 or by clamping.

FIG. 27 shows a sliding block 54, which can be arranged vertically displaceably in or on the profiled element 5. This sliding block 54 can also be used to attach a shelf 9, 10, 11 to the profiled element 5. The sliding block 54 is fixed at the set height by a screw 55.

FIG. 28 shows an example of an alternative translation-rotation fitting 7 as a sliding guide with two guideways 75 and guide elements 76 running therein on the cover panel 6.

The piece of furniture according to the invention has a fixed furniture body and a furniture element rotatably mounted in the furniture body, in particular a shelf having at least one bearing plane, which is designed as described above.

It is also conceivable to fix the furniture element directly to a floor and/or ceiling of a building room or to an outdoor floor such as a balcony or terrace floor.

### LIST OF REFERENCE SIGNS

2 Furniture element
3 Profile construction
31 Side opening
4 Base panel
41 Floor
411 Cutout
42 Edge region
43 Mounting region
44 Recess
45 Recess
46 Cutout
47 Hole
5 Profile
52 Groove
53 Holder
54 Sliding block
55 Screw
6 Cover panel
61 Top
62 Edge region
64 Recess
65 Recess
66 Cutout
7 Translation-rotation fitting
71 Bearing panel
72 Slot
73 Rolling element cage
74 Rolling elements
75 Guideway
76 Guide element
8 Receiving element
81 Base
82 Insertion socket
83 Projection
84 Cover strip
9 Shelf
10 Shelf
11 Shelf
13 Side panel
131 Adjustment element receptacle
132 Hole
15 Cover profile
151 Clip element
16 Cover profile
161 Clip element
17 Fastening element
18 Adjustment element
19 Decorative panel
20 Decorative panel
21 Mounting tool
R₁, R₂ Direction of rotation

1: A cuboidal furniture element (2), in particular a shelf having at least one bearing plane, comprising
a base panel (4),
a cover panel (6),
at least one profiled element (5) fixed between the base panel (4) and the cover panel (6),
wherein a translation-rotation fitting (7) is arranged on an underside of the base panel (4) facing away from the cover panel (6) and/or on an upper side of the cover panel (6) facing away from the base panel (4), by means of which fitting the furniture element (2) can be moved in a combined translational-rotational movement from a starting position into an opening end position and back into the starting position,
wherein
at least one receiving element (8) for fixing the at least one profiled element (5) is arranged in an edge region (42, 62) of the base panel (4) and the cover panel (6).

2: The furniture element (2) according to claim 1, wherein the at least one receiving element (8) extends in a direction of the longitudinal axes of the profiled elements (5).

3: The furniture element (2) according to claim 1, wherein the at least one receiving element (8) is designed to conically taper away from the edge regions (42, 62) of the base panel (4) and the cover panel (6).

4: The furniture element (2) according to claim 1, wherein the at least one receiving element (8) is integrally formed as a receiving contour on the base panel (4) or the cover panel (6).

5: The furniture element (2) according to claim 1, wherein the at least one receiving element (8) is designed as a separate component which is fastened to the base panel (4) or the cover panel (6).

6: The furniture element (2) according to claim 5, wherein the at least one receiving element (8) is adjustably fixed to the base panel (4) or the cover panel (6) in a plane of the base panel (4) or the cover panel.

7: The furniture element (2) according to claim 5, wherein the at least one receiving element (8) has a base (81) which can be fixed to the edge region (42, 62) of the base panel (4) or the cover panel (6) and an insertion socket (82) extending therefrom.

8: The furniture element (2) according to claim 7, wherein an elongated hole (44) is made in the edge region (42, 62) of the base panel (4) or of the cover panel (6), into which elongated hole (44) a pin (83) arranged in the base (81) projects, for guided displacement of the receiving element (8).

9: The furniture element (2) according to claim 1, wherein cover profiles (15, 16) can be fastened to the edge regions (42, 62) of the base panel (4) or the cover panel (6).

10: The furniture element (2) according to claim 1, wherein the base panel (4) and/or the cover panel (6) are concealed from the interior of the furniture element (2) by a decorative panel (20).

11: The furniture element (2) according to claim 8, wherein the decorative panel (20) is configured to be fixed in its mounting position by the cover profiles (15, 16).

12: The furniture element (2) according to claim 1, wherein the at least one profiled element (5) is tubular with a rectangular base surface.

13: The furniture element (2) according to claim 1, wherein the at least one profiled element (5) is tubular with a ring-segment-shaped base surface.

14: The furniture element (2) according to claim 1, wherein the at least one profiled element (5) is designed as a tubular connecting member, formed with a ring-segment-shaped base surface, of two decorative panels (19) integrated therewith.

15: The furniture element (2) according to claim 1, wherein a plurality of profiled elements (5) are arranged between the base panel (4) and the cover panel (6).

16: The furniture element (2) according to claim 1, wherein at least one corner region of the furniture element is formed by edges of adjacent side panels (13) or decorative panels (19) arranged close to one another or touching one another.

17: The furniture element (2) according to claim 1, wherein running grooves or sliding guides are formed in an underside of the base panel (4) and/or the upper side of the cover panel (6) in such a way that a base surface of the furniture element (2) in the starting position is congruent with a base surface of the furniture element (2) in the opening end position.

18: The furniture element (2) according to claim 1, wherein a rotational portion of the movement between the starting position and the opening end position is 90° or 180°.

19: The furniture element (2) according to claim 1, wherein the side panel (13) is fastened via fastening elements (17) projecting from the edge regions (42, 62) of the base panel (4) and the cover panel (6).

20: A piece of furniture, comprising a furniture body and a furniture element rotatably mounted in the furniture body, wherein the furniture element is designed as a furniture element (2) according to claim 1.
